(19) United States
(12) Patent Application Publication
(10) Pub. No.: US 2005/0247293 A1
(43) Pub. Date: Nov. 10, 2005

(54) Energy-releasing apparatus for energizing and covibrating fuel molecules and arranging reactant molecules

(75) Inventor: Tzu-Yuan Liao, Taipei City (TW)

Correspondence Address: TROXELL LAW OFFICE PLLC, SUITE 1404, 5205 LEESBURG PIKE, FALLS CHURCH, VA, 22041, US

(73) Assignee: Jewel Jar International Co., Ltd.

(21) Appl. No.: 11/184,969

(22) Filed: Jul. 20, 2005

(30) Foreign Application Priority Data
Mar. 22, 2004 (TW) 093204332

(51) Int. Cl. F02B 51/00

(52) U.S. Cl. 123/537; 123/536

(57) ABSTRACT

An energy-releasing apparatus for energizing and covibrating fuel molecules and arranging reactant molecules. The energy-releasing apparatus is installed in a predetermined position in an engine compartment of a vehicle. The energy-releasing apparatus includes at least one first energy-releasing section disposed beside the electrodes of the battery in the engine compartment chamber and at least one second energy-releasing section disposed in the engine compartment beside the intake duct of the combustion chamber. The first and second energy-releasing sections generate left-handed force field to arrange the electrons or the battery and the gas molecules in the intake duct. The left-handed force field further energizes the alkylate molecules of the fuel entering the combustion, whereby the molecules of all the reactants participating in the burning reaction are uniformly arranged and activated so as to achieve a complete reaction.

### BACKGROUND OF THE INVENTION

The present invention is related to an energy-releasing apparatus for energizing and covibrating fuel molecules and arranging reactant molecules.

A conventional magnetic fuel-saving apparatus includes a magnetized metal body mounted around the fuel line of a vehicle. When the fuel goes through the magnetic field generated by the fuel-saving apparatus, a magnetic force is applied to the fuel to arrange the molecules of the fuel. Accordingly, the fuel can more fully react and burn in the combustion chamber so as to save fuel.

However, in fact, the alkylate of the fuel can fully burn in the combustion chamber only in condition of sufficient oxygen and proper ignition. The above conventional magnetic fuel-saving apparatus simply applies a magnetic force to the fuel, while failing to energize all the reactants. Therefore, the alkylate of the fuel can hardly burn to an optimal extent.

### SUMMARY OF THE INVENTION

It is therefore a primary object of the present invention to provide an energy-releasing apparatus for energizing and covibrating fuel molecules and arranging reactant molecules. The energy-releasing apparatus can generate a left-handed force field for arranging the molecules of all the reactants participating in the burning reaction. Accordingly, the fuel molecules are energized to facilitate burning reaction and achieve a complete reaction. Therefore, the output power per unit fuel can be maximized.

According to the above object, the energy-releasing apparatus for energizing and covibrating fuel molecules and arranging reactant molecules of the present invention is installed in a predetermined position in an engine compartment of a vehicle. The energy-releasing apparatus includes at least one first energy-releasing section disposed beside the electrodes of the battery in the engine compartment chamber and at least one second energy-releasing section disposed in the engine compartment beside the intake duct of the combustion chamber. The first and second energy-releasing sections generate left-handed force field to arrange the electrons or the battery and the gas molecules in the intake duct. The left-handed force field further energizes the alkylate molecules of the fuel entering the combustion, whereby the molecules of all the reactants participating in the burning reaction are uniformly arranged and activated so as to achieve a complete reaction.

The present invention can be best understood through the following description and accompanying drawings-wherein:

### BRIEF DESCRIPTION OF THE DRAWINGS

FIG. 1 is a perspective view of a preferred embodiment of the present invention, showing the arrangement of the first energy-releasing sections;

FIG. 2 is a plane view of the preferred embodiment of the present invention, showing that the second energy-releasing sections are arranged near the intake duct; and

FIG. 3 is a plane view of the preferred embodiment of the present invention.

### DETAILED DESCRIPTION OF THE PREFERRED EMBODIMENTS

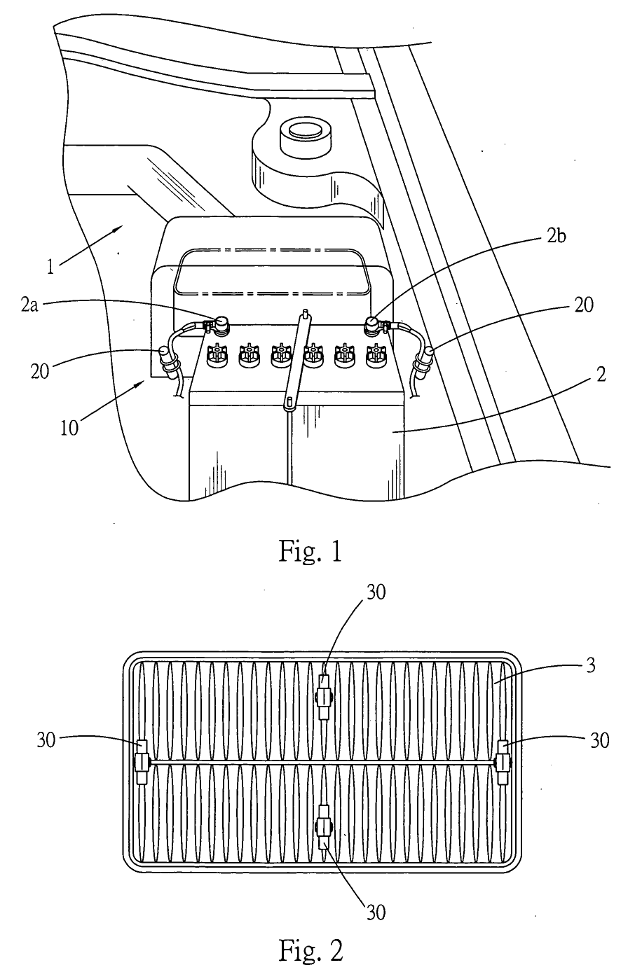

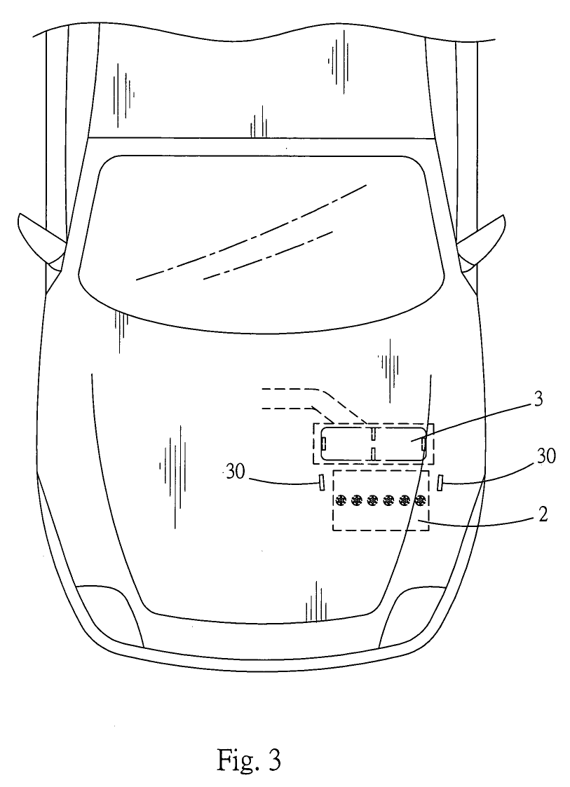

Please refer to FIGS. 1 to 3. The energy-releasing apparatus 10 for energizing and covibrating fuel molecules and arranging reactant molecules of the present invention is installed in the engine compartment 1 of a vehicle. The energy-releasing apparatus 10 is composed of two first energy-releasing sections 20 and four second energy-releasing sections 30.

The two first energy-releasing sections 20 are respectively disposed near the positive and negative electrodes 2a, 2b of the battery 2 in the engine compartment 1. Substantially, in this embodiment, the first energy-releasing sections 20 are respectively tied on the leads of the positive and negative electrodes 2a, 2b with binding straps. The first energy-releasing sections 20 generate left-handed force field to respectively act on the electrons flowing between the positive and negative electrodes 2a, 2b so as to tidily arrange the electrons. Accordingly, when the fuel is ignited to burn in the combustion chamber, the electrons can release maximum energy.

The second energy-releasing sections 30 are disposed in the engine compartment 1 near the intake duct for providing oxygen for the combustion chamber. Substantially, in this embodiment, the second energy-releasing sections 30 are respectively chucked on the intake end of the air filter 3. The second energy-releasing sections 30 generate left-handed force field to arrange the molecules of the gas flowing from the air filter 3 into the intake duct. Accordingly, the oxygen concentration per unit volume is enhanced so that sufficient oxygen can enter the combustion chamber for the fuel to fully react and burn.

The left-handed force field generated by the first energy-releasing sections 20 and second energy-releasing sections 30 acts on a large area in the engine compartment. After the reactants participating in the burning reaction are respectively arranged, the same large action field again uniformly acts on the reactants to keep the reactants in the arranged state until the reactants enter the combustion chamber for full reaction. Furthermore, the fuel molecules are also properly energized by the left-handed force field in the large action range. Therefore, the fuel molecules are activated to facilitate burning reaction.

In conclusion, the energy-releasing apparatus 10 for energizing and covibrating fuel molecules and arranging reactant molecules of the present invention can enhance the oxygen intake concentration per unit volume to provide sufficient oxygen for the fuel to fully oxidize and burn. Therefore, the incomplete burning can be avoided and reduce pollution. In addition, the energy resource can be fully utilized. By means of arranging the electrons and energizing and activating the alkylate molecules, the alkylate molecules can fully burn in the initial reaction. Therefore, the problem of accumulation of carbon caused by incomplete combustion and poor ignition in the combustion chamber can be improved. Accordingly, maximum power can be output.

The above embodiments are only used to illustrate the present invention, not intended to limit the scope thereof. Many modifications of the above embodiments can be made without departing from the spirit of the present invention.

1. An energy-releasing apparatus for energizing and covibrating fuel molecules and arranging reactant molecules, said energy-releasing apparatus being installed in a predetermined position in an engine compartment of a vehicle, the energy-releasing apparatus comprising:
at least one first energy-releasing section disposed beside the electrodes of the battery in the engine compartment chamber; and
at least one second energy-releasing section disposed in the engine compartment beside the intake duct of the combustion chamber, whereby the first and second energy-releasing sections generate left-handed force field to arrange the electrons or the battery and the gas molecules in the intake duct, the left-handed force field further energizing the alkylate molecules of the fuel entering the combustion, whereby the molecules of all the reactants participating in the burning reaction are uniformly arranged and activated so as to achieve a complete reaction.

2. The energy-releasing apparatus for energizing and covibrating fuel molecules and arranging reactant molecules as claimed in claim 1, wherein there are two first energy-releasing sections which are respectively disposed near the positive and negative electrodes of the battery.

3. The energy-releasing apparatus for energizing and covibrating fuel molecules and arranging reactant molecules as claimed in claim 1, wherein there are four second energy-releasing sections which are respectively disposed in the intake duct.

4. The energy-releasing apparatus for energizing and covibrating fuel molecules and arranging reactant molecules as claimed in claim 3, wherein the second energy-releasing sections are respectively disposed at intake end of an air filter in the intake duct.
